(19) United States
(12) Patent Application Publication
(10) Pub. No.: US 2002/0110681 A1
(43) Pub. Date: Aug. 15, 2002

(54) Plasma treated porous film

(76) Inventor: Moris M. Amon, Pittsford, NY (US)

Correspondence Address: ExxonMobil Chemical Company, P.O. Box 2149, Baytown, TX, 77522, US

(21) Appl. No.: 09/732,123

(22) Filed: Dec. 7, 2000

(51) Int. Cl. B32B 3/26

(52) U.S. Cl. 428/305.5; 428/543

(57) ABSTRACT

An open-celled, porous film layer includes voids. These voids have openings extending between adjacent voids such that paths exist so that liquids and/or vapors can traverse from one side of the film layer to the other. The layer may be in the form of a monolayer film or in the form of a multilayer film having the above-mentioned porous layer as a surface layer. The polymeric matrix of the porous film layer may be a polyolefin, such as polypropylene or high density polyethylene (HDPE). Such polyolefins are inherently hydrophobic. The water absorbency of open-celled polymeric films is improved by means of plasma treatment, whereby plasma is drawn into the pores of the film to make this pore space more hydrophilic.

### BACKGROUND

A porous film layer is provided. The layer includes voids which have openings extending between adjacent voids such that paths exist so that liquids and/or vapors can traverse from one side of the film layer to the other. Plasma is drawn into the void space of this porous layer to render the void space more hydrophilic.

To improve water-wetting of films made from inherently hydrophobic material, such as oriented polypropylene film, corona and flame treatments are commonly used in the industry. Plasma treatment can also achieve the same type of water-wetting improvement for films achieved by corona and flame treatments. Treatment of films with various types of plasma is described in U.S. Pat. Nos. 4,445,991, 4,897,305 and 5,981,079.

In order to render an open-celled porous film made from hydrophobic materials water absorbent, it is necessary to treat not only the outer surfaces of the film but also the inner surfaces of the pores.

### SUMMARY

There is provided an open-celled, porous, plasma-treated thermoplastic polymeric film layer, wherein said film layer is treated with plasma to make the pore space thereof more hydrophilic, and wherein said film layer has the following properties: (a) a receding contact angle for water of less than 35°; (b) a pore volume fraction of at least 0.40, and (c) a pore accessibility for water of at least 0.60.

There is also provided a method for plasma treating a porous thermoplastic polymeric film to make the pore space thereof more hydrophilic, wherein said film has at least one surface layer comprising exposed pores, wherein said method comprises the simultaneous steps of:

(a) passing said film between two electrodes, wherein one of said electrodes is a plasma generating electrode, which faces an outer surface of said film layer having exposed pores, and the other electrode is a plasma attracting electrode, which is positioned adjacent to the opposite side of the film;

(b) operating said plasma generating electrode under conditions sufficient to generate plasma; and

(c) operating said plasma attracting electrode under conditions sufficient to draw plasma generated in step (b) into the pore space of said porous film layer.

### DETAILED DESCRIPTION

Polyolefins, such as polyethylene and polypropylene, are inherently hydrophobic. The surfaces of these polymers must be treated to render these surfaces hydrophilic. Such treatments for making the surfaces of non-cavitated polyolefin films more hydrophilic include flame treatment and corona treatment. However, a most preferred treatment for the present open-celled, porous film surface is plasma treatment, especially particular types of plasma treatments as described below.

The porous film layer has voids with openings extending between adjacent voids such that paths exist so that liquids and/or vapors can traverse from one side of the film layer to the other.

To render an open-celled, porous film made from a polyolefin water absorbent, it is necessary to treat not only the outer surface of the film but also the inner surfaces of the pores. Plasma treatment is suited for such treatment. The plasma is a gas with relatively high concentrations of ions, free radicals, and free electrons. Under the right conditions, it can penetrate into the pores and react with their interior surfaces. For best results, the active zone of the plasma should be electrically or magnetically drawn onto the film surface.

Plasma may be drawn into the pores of the present porous film by use of two alternating current electrodes placed on opposite sides of the film. A first electrode, termed herein a plasma generating electrode, is operated at sufficient power to generate plasma. The plasma generating electrode is located a certain distance from the face of the film made up by the open-celled layer. The optimal distance between the film surface and the electrode depends on the gas pressure or vacuum level in the apparatus.

The second electrode is positioned on the opposite side of the film to be treated. This second electrode is termed herein a plasma attracting electrode. The plasma attracting electrode may be in the form of a roll and may physically contact and support the film during the plasma treatment. Especially when the plasma attracting electrode is in the form of a roll, it can also cool the film by acting as a heat sink to remove heat from the film during plasma treatment.

In order to attract plasma into the pores of the film, the plasma attracting electrode is operated at a much lower frequency than the plasma generating electrode. For example, plasma generating electrode may be operated in the megahertz range, e.g., from 5 MHz to 100 MHz, whereas the plasma attracting electrode may be operated in the kilohertz range, e.g., from 10 kHz to 500 kHz. The rapidly fluctuating polarity of the plasma generating electrode is effective at generating numerous collisions between electrons and atoms and thus maintains the plasma, but it also tends to confine the motion of ions and does not enhance their diffusion into the film's pores. In contrast, charged ions of the plasma are attracted to the plasma attracting electrode during every half cycle of its alternating voltage and because of the relatively long duration of this cycle, have enough time to penetrate the pores.

The plasma attracting electrode may be operated at a lower power than the plasma generating electrode. It is also possible to operate the plasma attracting electrode with direct current, but this has the disadvantage of charging up the film and can cause arcing.

One of the suitable processes for preparing open-celled film layers is described in U.S. application Ser. No. 08/686,287, filed Jul. 25, 1996.

In forming the opaque polymeric films of Ser. No. 081686,287, a polymeric matrix material is heated at least to a temperature at which the material becomes molten. A nucleating agent, such as a beta-nucleating agent, as described in the Shi et al U.S. Pat. No. 5,231,126, need not be included with or added to the polymeric matrix material. Melting of the polymeric matrix material may be accomplished in a conventional film extruder or the like. The melt is then subjected to, for example, melt extrusion to form a molten sheet or film. Known and conventional extrusion equipment and techniques may be used for this purpose. Typically, a screw-type extruder having a screw of a LID ratio of at least 5/1 and a flat or slot die is utilized for melting and extrusion purposes. Once the sheet is extruded, the sheet is cooled within a temperature range at which crystallization of the polymeric matrix material is initiated so that crystallites are formed within the material but the majority of the material remains in the amorphous state. Typically, crystallization of the matrix material at this stage does not exceed about 20%, preferably about 10% or less. Such controlled cooling of the molten sheet may be accomplished by a variety of means such as liquid-cooled take-off rolls, gaseous flows such as air flows and the like, as will be apparent to those of ordinary skill in the art.

In the processes of Ser. No. 08/686,287, the formed sheet of amorphous polymeric matrix material is subjected to stretching or orientation to significantly initiate crystallization and generate voids within the matrix material. Stretching of the matrix material sheet can be accomplished in a variety of manners and can be uniaxial stretching or biaxial stretching. If used, biaxial stretching preferably is conducted sequentially, although simultaneous stretching in both machine and transverse directions is also contemplated.

The uniaxial or biaxial stretching may be carried out to an extent and at a temperature calculated to obtain the maximum degree of opacity and optimal values of the desired physical characteristics. As the particular materials employed in forming the polymeric matrix material are varied, the conditions and degree of orientation or stretching may be altered accordingly to achieve the desired results. Generally, a machine direction orientation of about 3 to about 8 times and a transverse direction orientation of from about 3 to about 8 times yield polyolefin film structures of satisfactory characteristics including opacity.

Longitudinal or machine direction stretching or orientation may be advantageously conducted using two rolls running at different speeds according to the desired stretching ratio, and transverse stretching or orientation may be conducted using an appropriate tenter frame. It should be recognized that even so-called uniaxial stretching, such as created by drawing rolls, results in biaxial stresses since contraction of the sheet in the transverse direction which would normally occur is prevented by adhesion between the roll and the sheet.

After stretching and consequent formation of voids within the film, the film may be subjected to a heat treatment for thermofixing for a short period up to about 10 seconds or more. Additionally, one or both of the outer surfaces of the films may be treated to improve their surface energy such as by, for example, film chlorination, oxidation, plasma, flame or corona discharge treatments. Such surface treatments can improve the adhesion of the films to metal layers, inks and/or other coating or laminating materials. Thereafter, the film may be then wound up in a conventional manner using a wind-up type device.

The polymeric matrix material of the opaque films of Ser. No. 08/686,287 may be primarily composed of a wide variety of polymeric materials which crystallize, preferably as long as such materials meet certain criteria. In particular, suitable polymeric materials have a crystallization rate such that the material may be cooled to an amorphous state without significant crystallization in an industrial operation, but can thereafter be crystallized from the amorphous state upon stretching. Polymeric materials having a crystallization rate approximating that of polypropylene are particularly suitable for the processes of Ser. No. 081686,287. In addition, the polymeric matrix material, after being subjected to the processes of Ser. No. 08/686,287, preferably results in an opaque polymeric film which exhibits a significant degree of crystallinity such as, for example, at least about 30%, preferably at least about 50%.

Thus, the polymer of the matrix material may include one or more polyolefins alone or in conjunction with other polymeric materials which meet the above conditions. Polyolefins contemplated for inclusion in the matrix material may include polypropylene, polyethylene, polybutene and copolymers and blends thereof. Included may be distinct species of these polyolefins such as high density polyethylene, linear low density polyethylene, ultra low density polyethylene and linear low density ethylene copolymerized with less than about 10% by weight of another alpha olefin such as propylene and butylene. Also contemplated are copolymers of polyolefins including block copolymers of ethylene and propylene, other ethylene homopolymers, copolymers and terpolymers; or blends thereof. Other contemplated thermoplastic polymers include halogenated polyolefins; polyesters such as polyalkylene terephthalates including polybutylene terephthalate; polyethers; and polyamides such as nylons. Especially preferred in the process of Ser. No. 08/686,287 is an isotactic polypropylene containing at least about 80% by weight of isotactic polypropylene, preferably about 97 to 100% isotactic polypropylene. It is also preferred that the polypropylene have a melt flow index of from about 1 to about 10 g/10 min.

It is further contemplated in accordance with the concepts described in Ser. No. 081686,287, that the polymeric matrix material may also include other materials as long as the ability of the matrix material to form crystallites and create voids from these crystallites upon stretching while in an amorphous state is not significantly hindered. For example, the opacity of the film can be enhanced by the inclusion of from about 1 to 3% by weight of a pigment such as titanium dioxide, colored oxides and the like. While the pigment may be in a particle size such that it does not contribute in any material sense to void initiation in the polymeric matrix material, the use of pigments which contribute to void formation is not precluded. Additionally, other additives such as fillers, anti-oxidants, anti-static agents, slip agents, anti-tack agents, absorbents and the like in the customary amounts can be incorporated into the polymeric matrix material with the proviso as noted above.

Another suitable methods for making films with a surface layer with an open cell pore structure is described in U.S. application Ser. No. 091079,807, filed May 15, 1998. According to this method a cavitating agent is used with a particular polymeric matrix material, which is high density polyethylene (HDPE) or medium density polyethylene (MDPE). According to Ser. No. 091079,807, when this material is stretched, separations which form voids are formed not only horizontally, i.e. within or parallel to the plane of the film, but also in the vertical dimension or perpendicular to the plane of the film.

Further methods for making films with a surface layer with an open cell pore structure are described in U.S. Pat. No. 4,861,644. In U.S. Pat. No. 4,861,644, the microporous material substrate comprises (1) a matrix consisting essentially of linear ultrahigh molecular weight polyolefin, (2) a large proportion of finely divided water-insoluble siliceous filler, and (3) interconnecting pores.

As pointed out in U.S. Pat. No. 4,861,644, inasmuch as ultrahigh molecular weight (UHMW) polyolefin is not a thermoset polymer having an infinite molecular weight, it is technically classified as a thermoplastic. However, because the molecules are essentially very long chains, UHMW polyolefin, and especially UHMW polyethylene, softens when heated but does not flow as a molten liquid in a normal thermoplastic manner. In U.S. Pat. No. 4,861,644, it is stated that the very long chains and the peculiar properties they provide to UHMW polyolefin are believed to contribute in large measure to the desirable properties of the microporous material substrate.

In view of the flow characteristics of UHMW polyethylene, it is difficult to process into the form of a film. As described in U.S. Pat No. 4,861,644, a processing plasticizer is blended with UHMW polyethylene and precipitated silica to improve film forming characteristics. Examples of such processing plasticizers include processing oil such as paraffinic oil, naphthenic oil, or aromatic oil. After the film is formed the processing plasticizer is removed by an extraction step.

A particular process for forming the film of U.S. Pat No. 4,861,644 involves mixing filler, thermoplastic organic polymer powder, processing plasticizer and minor amounts of lubricant and antioxidant until a substantially uniform mixture is obtained. The weight ratio of filler to polymer powder employed in forming the mixture is essentially the same as that of the microporous material substrate to be produced. The mixture, together with additional processing plasticizer, is introduced to the heated barrel of a screw extruder. Attached to the extruder is a sheeting die. A continuous sheet formed by the die is forwarded without drawing to a pair of heated calender rolls acting cooperatively to form continuous sheet of lesser thickness than the continuous sheet exiting from the die. The continuous sheet from the calender then passes to a first extraction zone where the processing plasticizer is substantially removed by extraction with an organic liquid which is a good solvent for the processing plasticizer, a poor solvent for the organic polymer, and more volatile than the processing plasticizer. Usually, but not necessarily, both the processing plasticizer and the organic extraction liquid are substantially immiscible with water. The continuous sheet then passes to a second extraction zone where the residual organic extraction liquid is substantially removed by steam and/or water. The continuous sheet is then passed through a forced air dryer for substantial removal of residual water and remaining residual organic extraction liquid. From the dryer the continuous sheet, which is microporous material substrate, is passed to a take-up roll.

After the processing plasticizer is extracted from the film, biaxial stretching may, optionally, take place.

A microporous substrate described in U.S. Pat No. 4,861,644, or a substrate similar thereto, is believed to be commercially available from PPG Industries, Inc., under the tradename Teslin.

### EXAMPLE 1

This Example describes the preparation of a monolayer polypropylene film prepared in accordance with the procedure of Ser. No. 08/686,287. It further describes the plasma treatment of this film according to the present application and compares the properties of the plasma-treated, corona-treated and untreated film.

Polypropylene resin (MP=320° F., melt index=3) sold under the tradename Fina 3371 was melted in an extruder with a screw of a LID ratio of about 20/1 and extruded into sheet form at a melt temperature of about 400° F. The surface of the molten sheet was briefly cooled over a roll containing a circulating fluid at about 203° F. to avoid the film sticking to succeeding rolls. Subsequently, the sheet was thermally conditioned over two consecutive rolls containing a circulating fluid at about 245° F. Then, a rapid 5.35x machine direction stretch was imposed by means of a fast roll in conjunction with a slow roll. The fast (cold) and slow (hot) rolls for conducting the machine direction stretching procedure were rubber-clad to prevent slippage of the sheet. The fast roll as well as a subsequent cooling roll contained circulating fluid at 244° F. It was believed that the polymeric matrix material was largely uncrystallized (except for a skin layer) up to the point of the stretch in the machine direction (MD).

The film was then transported for transverse direction (TD) stretching into a tenter at a speed of 9.7 ft/min. The TD stretch ratio was about 5.5x. The film was heated by infrared heaters during this operation. At the tenter exit, the film was wound on a pneumatically driven winder.

One roll of film was treated by an oxygen-argon plasma under vacuum, according to the conditions in Table 1. The film was supported by an 18 inch diameter, 15 inch wide cooled roll during treatment. The plasma was generated by a flat 12 inch high by 15 inch wide plate electrode placed 2.0 inches from the film at its closest point, operating at mean power of 200 W and frequency of 13.5 MHz. Optionally, a power of 50 W at a much lower frequency of about 50 kHz was also applied to the roll. The function of the roll potential was to accelerate the massive ions toward the film every half cycle, since at a plasma generating electrode frequency of 13.5 MHz, the ions are efficiently generated but are essentially entrapped away from the film. It will be noted that above-mentioned wattage values are for the power applied to the plasma generating electrode and the roll (i.e. the plasma attracting electrode); the actual power delivered to the plasma is less because of losses, especially at 13.5 MHz.

Another roll of the same film was corona treated conventionally according to conditions in Table 2. Two levels of treatment power were used.

The results are shown in Table 3 below. The “% accessible pores” and surface contact angle are calculated from data obtained in a single measurement sequence on a Cahn micro-balance. The measurement and calculation sequence involved in arriving at the former is described by the following list:

t=sample thickness, measured

A=sample area, measured

V=total sample volume=A multiplied by t

m=sample mass, measured

ρ=polymer density 0.91 g/cc, known

V_{S}=solid volume in sample=m/p

V_{P}=pore volume=V−V_{S}

φ=pore volume fraction (porosity)=Vₚ/V,0<φ<1

M_{w}=mass of water picked up by wicking

ρ_{w}=density of water

V_{W}=volume of water picked up by wicking=m_{w}/p_{w}

α=accessible volume fraction of pores=V_{W}/V_{P}, 0<α<1

For an absorbent film, a is most preferably close to 1. In addition, to assure surface wetting, the contact angle should be close to 0°.

Properties of an untreated film, plasma treated films and corona treated films are shown in Table 3.

TABLE 1
Plasma treatment conditions

| | | |
|---|---|---|
| web width | 15 | in |
| line speed | 6 or 12 | ft/min |
| 13.5 MHz power | 200 | W |
| 50 kHz power | 0 or 50 | W |
| Ar flow rate | 10 | scc/min |
| O₂ flow rate | 40 | scc/min |
| Plasma pressure | ˜10⁻² | mbar |
| Tension, unwind + | 10 | lb |
| rewind | | |

TABLE 2
Corona treatment conditions

| | | |
|---|---|---|
| Web width | 15 | in |
| Line speed | 200 | ft/min |
| Power | 1.75 & 3.5 | kW |

TABLE 3
Characteristics of films

| | Receding | | Pore |
|---|---|---|---|
| | contact | Pore volume | accessibility |
| | angle | fraction φ | α |
| Untreated | 78° | 0.50 | 0.15 |
| Plasma, 6 fpm, 0 W | 24° | 0.46 | 0.71 |
| Plasma, 12 fpm, | 25° | 0.53 | 0.72 |
| 0 W | | | |
| Plasma, 6 fpm, | 0° | 0.53 | 0.96 |
| 50 W | | | |
| Plasma, 12 fpm, | 2° | 0.50 | 1.15 |
| 50 W | | | |
| Corona, 1.75 kW | 49° | 0.55 | 0.57 |
| Corona, 3.5 kW | 44° | 0.51 | 0.23 |

It will be noted that the value above 1 (i.e. 1. 15) for the plasma treated film at 12 feet per minute (fpm) and 50 W is an artifact due to unaccounted water-polymer contact angles inside the sample. The excess of 0.15 agrees with the pore accessibility of the untreated film, which should have been about zero theoretically. Since the upper most value 10 (1.15) is at least 0.15 too high and the lower most value (0.15) is about 0.15 too high, it would appear that more accurate individual values for pore accessibility a would be attained by subtracting 0.15 for each of the a values given in Table 3.

What is claimed is

1. A plasma treated thermoplastic, open-celled, porous polymeric film layer, wherein said film layer is treated with plasma to make the pore space thereof more hydrophilic, and wherein said film layer has the following properties: (a) a receding contact angle for water of less than 35°; (b) a pore volume fraction of at least 0.40, and (c) a pore accessibility for water of at least 0.60.

2. A monolayer film comprising the film layer of claim 1.

3. A multi layer film comprising a surface layer of the film layer according to claim 1.

4. A film layer according to claim 1, wherein the polymer of the matrix material of said layer is a polyolefin selected from the group consisting of polypropylene, polyethylene, polybutylene and copolymers and blends thereof.

5. A film layer according to claim 1, wherein the polymer of the matrix material of said layer is an isotactic polypropylene, containing at least about 80% by weight of isotactic polypropylene.

6. A film layer according to claim 1 having a receding contact angle for water of less than 10°, a pore volume fraction of at least 0.45, and a pore accessibility of at least 0.75.

7. A method for plasma treating a porous thermoplastic polymeric film to make the pore space thereof more hydrophilic, wherein said film has at least one surface layer comprising exposed pores, wherein said method comprises the simultaneous steps of:
(a) passing said film between two electrodes, wherein one of said electrodes is a plasma generating electrode, which faces an outer surface of said film layer having exposed pores, and the other electrode is a plasma attracting electrode, which is positioned adjacent to the opposite side of the film;
(b) operating said plasma generating electrode under conditions sufficient to generate plasma; and
(c) operating said plasma attracting electrode under conditions sufficient to draw plasma generated in step (b) into the pore space of said porous film layer.

8. A method according to claim 7, wherein said plasma attracting electrode is in the form of a roll, which is in physical contact with the film being plasma treated.

9. A method according to claim 8, wherein said roll is a cooling roll.

10. A method according to claim 8, wherein said plasma generating electrode is operated at a higher power and frequency than said plasma attracting electrode.

11. A method according to claim 8, wherein said plasma generating electrode is operated at a frequency of from 5 MHz to 100 MHz, and said plasma attracting electrode is operated at a frequency of from 10 kHz to 500 kHz.
